(19) United States
(12) Patent Application Publication
(10) Pub. No.: US 2024/0128553 A1
(43) Pub. Date: Apr. 18, 2024

(54) BATTERY HOUSING AND POWER SOURCE

(71) Applicant: VOLTGO POWER INC., WILMINGTON, DE (US)

(72) Inventor: JINFENG HU, Redondo Beach, CA (US)

(21) Appl. No.: 17/967,913

(22) Filed: Oct. 18, 2022

(51) Int. Cl. H01M 50/121; H01M 50/119; H01M 50/567

(52) U.S. Cl. CPC H01M 50/121; H01M 50/119; H01M 50/567

(57) ABSTRACT

A battery housing and a power source are provided. The battery housing includes a plastic housing body with an upper plate, a bottom plate and side walls. Side walls are individually connected between the upper plate and the bottom plate. And the upper plate, the bottom plate and the side walls together define a holding cavity to hold a battery. The upper plate includes two through-holes. The plastic housing body also includes two electrode connection terminals for connecting electrodes of the battery. The two electrode connection terminals are individually penetrated into the two through-holes. Mental plates are embedded in the side walls to improve structural strength of the battery housing and to prevent the battery housing from deformation. Screw holes are embedded in the metal plates to facilitate rapid assembly and installation among multiple battery housings.

### TECHNICAL FIELD

The disclosure relates to a technical field of plastic housings, and more particularly to a battery housing and a power source.

### BACKGROUND

At present, commonly used battery housings are plastic injection molded.

The existing plastic battery housings can hold batteries therein to provide power source for devices or systems such as caravans, golf carts, uninterruptible power systems (USP), and small energy storage systems. When it is required to fix the plastic battery housing on a wall or other positions, or it is required to connect multiple plastic battery housings together for use, in order to fix or connect the plastic battery housing, it is necessary to perforate the plastic battery housing owning to the plastic battery housing being not equipped with mounting structures. However, perforating the plastic battery housing may result in weak structural strength of the plastic battery housing, which may easily lead to deformation or water leakage of the plastic battery housing. In addition, connecting structures disposed in holes obtained by perforating the plastic battery housing are limited by the plastic battery housing and their self-structures, which results in low torque forces of connections among the connecting structures and the plastic battery housing. Furthermore, it is easy to have “sliding wire” phenomenon when fixing the plastic battery housing, which causes the plastic battery housing to be not firmly fixed.

### SUMMARY

In order to overcome defects and deficiencies of the above related art, a battery housing and a power source are provided.

On the one hand, the disclosure provides a battery housing, which includes a plastic housing body with an upper plate, a bottom plate and side walls and metal plates. The side walls are individually connected between the upper plate and the bottom plate to enclose to define a holding cavity to hold a battery. The upper plate is provided with a first through-hole and a second through-hole. The plastic housing body further includes a first electrode connection terminal and a second electrode connection terminal for connecting electrodes of the battery. The first electrode connection terminal is threaded on the first through-hole, and the second electrode connection terminal is threaded on the second through-hole. The metal plates are respectively embedded in the side walls.

In an embodiment of the disclosure, the metal plates include a first metal plate and a second metal plate. The side walls include a first side wall and a second side wall, which are arranged opposite to each other and connected between the upper plate and the bottom plate. The first metal plate is embedded in the first side wall, and the second metal plate is embedded in the second side wall. The first side wall is provided with first mounting holes, which extend from an outside of the first side wall into the first metal plate. The second side wall is provided with second mounting holes, which extend from an outside of the second side wall into the second metal plate.

In an embodiment of the disclosure, the first mounting holes are provided on edges of the first side wall and the second mounting holes are provided on edges of the second side wall.

In an embodiment of the disclosure, the side walls further include a third side wall and a fourth side wall, which are arranged opposite to each other, connected between the upper plate and the bottom plate and connected between the first side wall and the second side wall. The first metal plate is provided with a first extension and a second extension at opposite ends respectively. The first extension part extends from an end of the first metal plate adjacent to the third side wall to an end of the third side wall adjacent to the first side wall. The second extension part extends from an end of the first metal plate adjacent to the fourth side wall to an end of the fourth side wall adjacent to the first side wall. The third side wall is provided with third mounting holes, which extend from an outside of the third side wall into the first extension part. The fourth side wall is provided with fourth mounting holes, which extend from an outside of the fourth side wall into the second extension part.

In an embodiment of the disclosure, the metal plates further include a third metal plate and a fourth metal plate. The third metal plate is embedded in another end of the third side wall adjacent to the bottom plate. The fourth metal plate is embedded in another end of the fourth side wall adjacent to the bottom plate. The third side wall is further provided with fifth mounting holes, which extend from the outside of the third side wall into the third metal plate. The fourth side wall is further provided with sixth mounting holes, which extend from the outside of the fourth side wall into the fourth metal plate.

In an embodiment of the disclosure, the upper plate is provided with a protruding part and a protruded height of the protruding part is higher than that of the first electrode connection terminal and the second electrode connection terminal.

In an embodiment of the disclosure, the battery housing further includes a first fixing component, first mounting components, a second fixing component and second mounting components. The first fixing component is provided with first mounting through-holes and the second fixing component is provided with second mounting through-holes. The first fixing component is rested on the first side wall, and the first mounting components are successively penetrated into the first mounting through-holes and the first mounting holes correspondingly to connect the first fixing component to the first side wall. The second fixing component is rested on the second side wall, and the second mounting components are successively penetrated into the second mounting through-holes and the second mounting holes correspondingly to connect the second fixing component to the second side wall.

In an embodiment of the disclosure, the battery housing further includes a third fixing component, third mounting components, a fourth fixing component and fourth mounting components. The third fixing component is provided with third mounting through-holes, and the fourth fixing component is provided with fourth mounting through-holes. The third fixing component is rested on the third side wall, and the third mounting components are successively penetrated into the third mounting through-holes and the third mounting holes correspondingly to connect the third fixing component to the third side wall. The fourth fixing component is rested on the fourth side wall, and the fourth mounting components are successively penetrated into the fourth mounting through-holes and the fourth mounting holes correspondingly to connect the fourth fixing component to the fourth side wall.

In an embodiment of the disclosure, a concave part is disposed on a middle position of the outside of the first side wall. The concave part is provided with seventh mounting holes, which extend from the outside of the first side wall into the first metal plate. The battery housing further includes a pairing plate and fifth mounting components. The pairing plate is provided with fifth mounting through-holes, which correspond to the seventh mounting holes. The fifth mounting components are successively penetrated into the fifth mounting through-holes and the seventh mounting holes correspondingly to connect the pairing plate to the concave part of the first side wall.

On the other hand, the disclosure provides a power source, which includes the battery housing as described above and the battery with a positive electrode and a negative electrode. The battery is disposed in the holding cavity of the battery housing, and the positive electrode is connected to the first electrode connection terminal and the negative electrode is connected to the second electrode connection terminal.

From the above description, the disclosure has advantages that:
1. the battery housing of the disclosure is provided with a plurality of metal plates embedded in corresponding side walls to enhance the structural strength of the side walls, which in turn can enhance the overall structural strength of the battery housing;
2. the disclosure provides the first mounting holes disposed on the edges of the first side wall, the second mounting holes disposed on the edges of the second side wall, the pairing plate and the fifth mounting components; when it is required to connect the multiple battery housings together, the mounting holes (such as the first mounting holes and/or the second mounting holes), the pairing plate and the fifth mounting components can be cooperative to connect the multiple battery housings;
3. the protruded height of the protruding part is higher than that of the first electrode connection terminal and the second electrode connection terminal, which can prevent accidental electric shock and protect the first electrode connection terminal and the second electrode connection terminal from falling objects;
4. the disclosure provides the first fixing component abutted against the first side wall, the first mounting components, the second fixing component abutted against the second side wall, and the second mounting components, which can make the battery housing be fixed on the ground or the wall by the first fixing component and the second fixing component.

### BRIEF DESCRIPTION OF DRAWINGS

In order to more clearly explain technical schemes in embodiments of the disclosure, the following will briefly introduce the attached drawings needed to be used in the embodiments. Apparently, the attached drawings in the following description are only some of the embodiments of the disclosure. For those skilled in the field, other drawings can be obtained from these drawings without any creative effort.

FIG. 1 is a schematic sectional diagram of a battery housing according to a first embodiment of the disclosure.

FIG. 2 is another schematic sectional diagram of the battery housing according to the first embodiment of the disclosure.

FIG. 3 is a still another schematic sectional diagram of a part of the battery housing according to the first embodiment of the disclosure.

FIG. 4 is a front view of the battery housing according to the first embodiment of the disclosure.

FIG. 5 is a vertical view of the battery housing according to the first embodiment of the disclosure.

FIG. 6 is a left view of a battery housing without installing a pairing plate according to the first embodiment of the disclosure.

FIG. 7 is a left view of a battery housing with installing a pairing plate according to the first embodiment of the disclosure.

FIG. 8 is a schematic structural diagram of a power source according to a second embodiment of the disclosure.

FIG. 9A is a schematic diagram of a connecting mode of multiple battery housings in a power source according to the second embodiment of the disclosure.

FIG. 9B is another schematic diagram of a connecting mode of multiple battery housings in a power source according to the second embodiment of the disclosure.

### DESCRIPTION OF REFERENCE NUMERALS

1-battery housing; 10-plastic housing body; 11-side wall; 12-upper plate; 13-bottom plate; 14-holding cavity; 15-first electrode connection terminal; 16-second electrode connection terminal; 20-mental plate; 21-first mental plate; 22-second mental plate; 23-third mental plate; 24-fourth mental plate; 51-first fixing component; 52-first mounting component; 53-second fixing component; 54-second mounting component; 61-third fixing component; 62-third mounting component; 63-fourth fixing component; 64-fourth mounting component; 71-pairing plate; 72-fifth mounting component; 111-first side wall; 112-second side wall; 113-third side wall; 114-fourth side wall; 121-first through-hole; 122-second through-hole; 123-protruding part; 211-first extension part; 212-second extension part; 511-first mounting through-hole; 531-second mounting through-hole; 611-third mounting through-hole; 631-fourth mounting through-hole; 1111-first mounting hole; 1112-concave part; 1113-seventh mounting hole; 1121-second mounting hole; 1131-third mounting hole; 1132-fifth mounting hole; 1141-fourth mounting hole; 1142-sixth mounting hole; 100-power source; 101-battery; 1011-positive electrode; 1012-negative electrode.

### DETAILED DESCRIPTION OF EMBODIMENTS

The technical schemes in the embodiments of the disclosure will be described clearly and completely below in combination with the drawings in the embodiments of the disclosure. Apparently, the described embodiments are only some of the embodiments of the disclosure, not all of the embodiments. Based on the embodiments of the disclosure, all of other embodiments obtained by those skilled in the field without creative effort belong to the protection scope of the disclosure.

### Embodiment 1

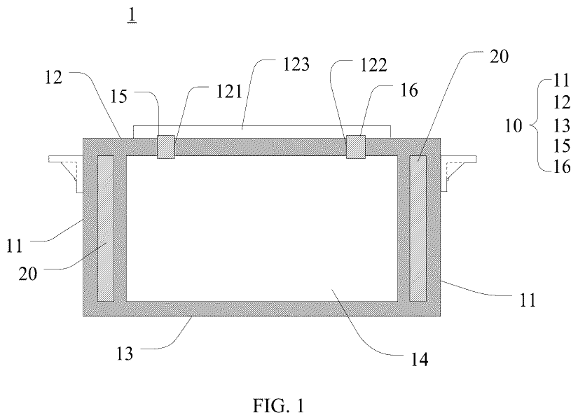

As shown in FIG. 1, the disclosure provides a battery housing 1, including a plastic housing body 10 and multiple mental plates 20.

The plastic housing body 10 includes multiple side walls 11, an upper plate 12 and a bottom plate 13. The multiple side walls 11 are individually connected between the upper plate 12 and the bottom plate 13. The multiple side walls 11, the upper plate 12 and the bottom plate 13 together enclose to define a holding cavity 14 to hold a battery. For example, the battery is a storage battery, a solid lithium ion battery, a liquid lithium ion battery, etc. The plastic housing body 10 can be a housing component made of engineering plastic alloy. The plastic housing body 10 made of plastic greatly reduces a weight of the battery housing 1 and is easy to carry.

As shown in FIG. 1, the upper plate 12 is provided with a first through-hole 121 and a second through-hole 122; the plastic housing body 10 includes a first electrode connection terminal 15 and a second electrode connection terminal 16, which are respectively disposed in the first through-hole 121 and the second through-hole 122. In an illustrated embodiment of the disclosure, the first electrode connection terminal 15 and the second electrode connection terminal 16 protrude from the upper plate 12; the first electrode connection terminal 15 is connected to a positive electrode of the battery, and the second electrode connection terminal 16 is connected to a negative electrode of the battery. In another embodiment of the disclosure, the first electrode connection terminal 15 is connected to a negative electrode of the battery, and the second electrode connection terminal 16 is connected to a positive electrode of the battery. Polarity of the electrodes connected to the first electrode connection terminal 15 and the second electrode connection terminal 16 can be changed according to actual situation, which are not limited herein.

In an illustrated embodiment of the disclosure, the multiple mental plates 20 are individually embedded in the multiple side walls 11. The metal plates 20 can be made of stainless steel or alloy to improve structural strength of the multiple side walls 11, thereby improving an overall structural strength of the battery housing 1.

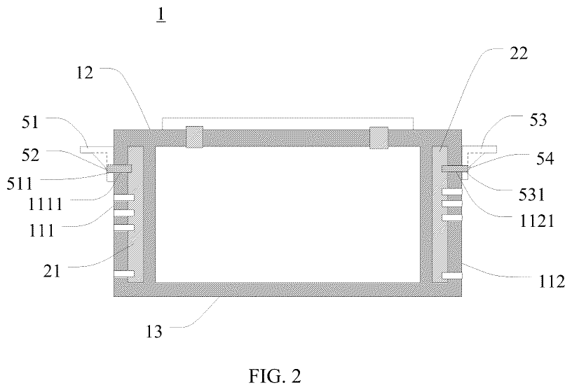

In an embodiment of the disclosure, as shown in FIG. 2, the multiple metal plates 20 include a first metal plate 21 and a second metal plate 22. The multiple side walls 11 include a first side wall 111 and a second side wall 112.

As shown in FIG. 2, the first side wall 111 and the second side wall 112 are disposed opposite to each other and connected between the upper plate 12 and the bottom plate 13; the first metal plate 21 is embedded in the first side wall 111, and the second metal plate 22 is embedded in the second side wall 112. The first side wall 111 is provided with first mounting holes 1111, which extend from an outside of the first side wall 111 into the first metal plate 21. The second side wall 112 is provided with second mounting holes 1121, which extend from an outside of the second side wall 112 into the second metal plate 22. In an illustrated embodiment of the disclosure, the first mounting holes 1111 and the second mounting holes 1121 extend into the first metal plate 21 and the second metal plate 22 respectively, namely that they are penetrated into the metal plates deeply. When a fixing plate or a connecting plate is fixed on a side wall through the mounting holes, a metal plate bears a torque force because the mounting holes extend into the metal plate. For example, the metal plates are embedded with screw holes, so that the mounting holes and the screw holes are connected as a whole structure. Therefore, the first fixing component 51 can be disposed on the first mounting holes 1111 to connect the first fixing component 51 to the first mental plate 21. Since the structural strength of the metal plate is higher than that of the plastic housing, the battery housing 1 is not easy to deform when the metal plate bears the torque force. Therefore, the structural strength of the battery housing 1 has been greatly improved. In another embodiment of the disclosure, the first mounting holes and the second mounting holes can extend into other position according to actual situation. For example, the first mounting holes and the second mounting holes can extend through the entire metal plate, which is not limited herein.

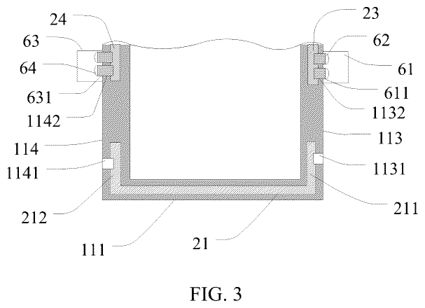

In an embodiment of the disclosure, as shown in FIG. 3, the multiple side walls further include a third side wall 113 and a fourth side wall 114, which are disposed opposite to each other, connected between the upper plate 12 and the bottom plate 13, and connected between the first side wall 111 and the second side wall 112.

As shown in FIG. 3, a first extension part 211 and a second extension part 212 are disposed on opposite ends of the first metal plate 21 respectively; the first extension part 211 extends from an end of the first metal plate 21 adjacent to the third side wall 113 to an end of the third side wall 113 adjacent to the first side wall 111; the second extension part 212 extends from another end of the first metal plate 21 adjacent to the fourth side wall 114 to an end of the fourth side wall 114 adjacent to the first side wall 111. The third side wall 113 is provided with third mounting holes 1131, which extend from an outside of the third side wall 113 into the first extension part 211; and the fourth side wall 114 is provided with fourth mounting holes 1141, which extend from an outside of the fourth side wall 114 into the second extension part 212. The structure of the second metal plate 22 is similar to that of the first metal plate 21, which can be referred. The first mental plate 21 is provided with the first extension part 211 and the second extension part 212, which are corresponding to the third mounting holes 1131 and the fourth mounting holes 1141; the third mounting holes 1131 extend from the outside of the third side wall 113 into the first extension part 211 and the fourth mounting holes 1141 extend from the outside of the fourth side wall 114 into the second extension part 212. Therefore, when multiple battery housings 1 need to be connected to form a power source with greater electric power, the connecting plate can be installed on the third mounting holes 1131 and the fourth mounting holes 1141. At the same time, since the third mounting holes 1131 and the fourth mounting holes 1141 extend into the extension parts of the first metal plate 21, the metal plate bears the torque force, so that the structural strength of the battery housing 1 is higher. The second metal plate 22 is also provided with two extension parts, and the structure of the second metal plate 22 is symmetrical with that of the first metal plate 21. Therefore, the structure of the second mental plate 22 can refer to that of the first mental plate 21; the details will not be repeated here.

As shown in FIG. 3, the multiple metal plates 20 further include a third metal plate 23 and a fourth metal plate 24, and the third metal plate 23 is embedded in another end of the third side wall 113 adjacent to the bottom plate 13. The fourth metal plate 24 is embedded in another end of the fourth side wall 114 adjacent to the bottom plate 13. The third side wall 113 is provided with fifth mounting holes 1132, which extend from the outside of the third side wall 113 into the third metal plate 23. The fourth side wall 114 is provided with sixth mounting holes 1142, which extend from the outside of the fourth side wall 114 into the fourth metal plate 24. Since the mounting holes can extend into the metal plates, the metal plates bear the torque force of fixation or connection. Since the structural strength of the metal plates is higher than that of the plastic housing body, when the metal plates bear the torque force, the structure of the battery housing 1 is not easy to deform, and the structural strength of the battery housing 1 is higher.

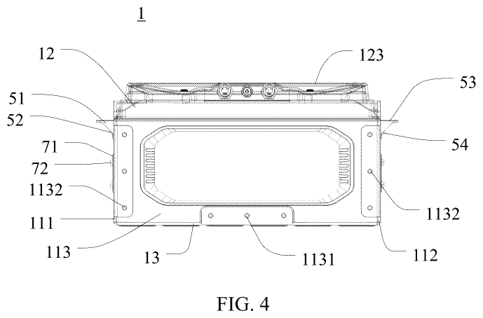

In an embodiment of the disclosure, as shown in FIG. 2 and FIG. 4, the battery housing 1 further includes a first fixing component 51, first mounting components 52 and a second fixing component 53, second mounting components 54. The first fixing component 51 is provided with first mounting through-holes 511, and the second fixing component 53 is provided with second mounting through-holes 531. The first fixing component 51 is abutted against the first side wall 111, and the first mounting components 52 are successively penetrated into the first mounting through-holes 511 and the first mounting holes 1111 to connect the first fixing component 51 to the first side wall 111. The second fixing component 53 is abutted against the second side wall 112, and the second mounting components 54 are successively penetrated into the second mounting through-holes 531 and the second mounting holes 1121 to connect the second fixing component 53 to the second sidewall 112.

In an illustrated embodiment of the disclosure, as shown in FIG. 4, the first fixing component 51 and the second fixing component 53 are L-shaped metal plates. The L-shaped metal plate includes a first fixing plate and a second fixing plate, which are perpendicular to each other to form an L shape. The second fixing plate of the first fixing component 51 is provided with the first mounting through-holes 511. The second fixing plate of the second fixing component 53 is provided with the second mounting through-holes 531. Namely, when the L-shaped metal plate is abutted against the first side wall 111, the first mounting through-holes 511 are disposed on the second fixing plate. When the L-shaped metal plate is abutted against the second side wall 112, the second mounting through holes 531 are disposed on the second fixing plate. The first fixing plate is provided with a hanging fixing part, which facilitates carrying or fixing according to actual needs. When the battery housing 1 needs to be fixed on the wall or the ground, the hanging fixing part of the first fixing plate is provided with a connecting component. For example, the connecting component can be a screw. When the battery housing 1 needs to be carried, the connecting component disposed on the hanging fixing part of the first fixing plate can be a hanging rope. The first mounting components 52 or the second mounting components 54 are disposed on the second fixing plate of the L-shaped metal plate. For example, the first mounting components 52 and the second mounting components 54 can be screws. The screws are fixed with the first metal plate 21 through the first mounting through-holes 511 and the first mounting holes 1111, which makes the first fixing component 51 be abutted against the first side wall 111. Therefore, when the first fixing component 51 is fixed on the first side wall 111 through the first mounting components 52, the first mental plate 21 bears the torque force. The connection mode of the second fixing component 53 can refer to that of the first fixing component 51; the details will not be repeated here.

In an embodiment of the disclosure, as shown in FIG. 3, the battery housing 1 further includes a third fixing component 61, third mounting components 62, a fourth fixing component 63 and fourth mounting components 64. The third fixing component 61 is provided with third through-holes 611, and the fourth fixing component 63 is provided with fourth through-holes 631. The third fixing component 61 is abutted against the third side wall 113, and the third mounting components 62 are successively penetrated into the third mounting through-holes 611 and the third mounting holes 1131 correspondingly to connect the third fixing component 61 to the third side wall 113. The fourth fixing component 63 is abutted against the fourth side wall 114, and the fourth mounting components 64 are successively penetrated into the fourth mounting through-holes 631 and the fourth mounting holes 1141 correspondingly to connect the fourth fixing component 63 to the fourth side wall 114. For example, the third fixing component 61 and the fourth fixing component 63 can be a fixing plate and the fixing plate can be an L-shaped metal plate. The third mounting components 62 and the fourth mounting components 64 can be screws. The connection mode of the third fixing component 61 and the third mounting components 62, and the connection mode of the fourth fixing component 63 and the fourth mounting components 64 in the embodiment can refer to the connection mode of the first fixing component 51 and the first mounting components 52 above, the details will not be repeated here.

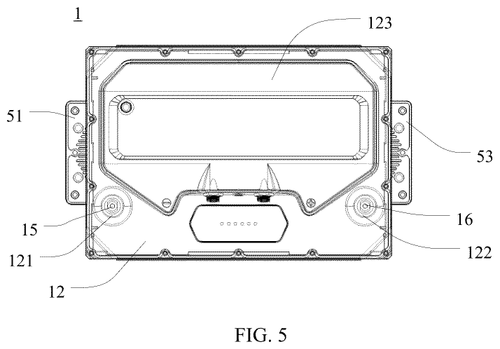

In an illustrated embodiment of the disclosure, as shown in FIG. 5, the upper plate 12 is provided with a protruding part 123, and a protruded height of the protruding part 123 is higher than that of the first electrode connection terminal 15 and the second electrode connection terminal 16. In the embodiment of the disclosure, although the first electrode connection terminal 15 and the second electrode connection terminal 16 protrude from the upper plate 12, a protruded height does not exceed that of the protruding part 123. For one reason, accidental electric shock can be prevented. When a user accidentally drops conductive objects onto the upper plate 12 of the battery housing 1, the conductive objects directly slide out nor reserve on the upper plate 12 because the protruded height of the protruding part 123 is higher than that of the first electrode connection terminal 15 and the second electrode connection terminal 16. Therefore, the user will not be in danger of electric shock when picking up the conductive objects due to contact with the first electrode connection terminal 15 and the second electrode connection terminal 16. For another reason, when objects fall onto the upper plate 12 of the battery housing 1, the first electrode connection terminal 15 and the second electrode connection terminal 16 can be protected from direct collision with the falling objects, which in turn causes damage to the first electrode connection terminal 15 and the second electrode connection terminal 16.

In an illustrated embodiment of the disclosure, as shown in FIG. 4 to FIG. 5, the protruding part 123 and the upper plate 12 enclose to define a cavity, which is used to place a battery management chip. The battery management chip is electrically connected with the battery placed in the holding cavity. The positive and negative electrodes of the battery are connected with the battery management chip, and then the battery management chip is electrically connected with the first electrode connection terminal 15 and the second electrode connection terminal 16. For example, the battery management chip can be a battery management system, which is mainly used to detect and control voltage, current, temperature and other parameters of the battery, and also to provide low-voltage, overvoltage, overcurrent, short circuit, over temperature, low temperature and other protection for the battery. The protruding part 123 is also provided with a communication port and a switch button. The switch button is used to control connection and disconnection between the first electrode connection terminal 15 and the second electrode connection terminal 16 in the battery housing 1 and the positive and negative electrodes of the battery, thereby controlling start or stop of the power source when the battery is installed in the battery housing. The communication port is used for communicating with the battery management chip. For example, the communication port is a serial port, and the serial port can be a cluster communication port (COM).

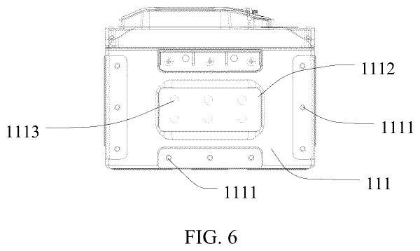

In an illustrated embodiment of the disclosure, as shown in FIG. 6, the first mounting holes 1111 are disposed on edges of the first side wall 111. For example, the first mounting holes 1111 are disposed on four edges of the first side wall 111, which can meet different needs of the battery housing. For example, when the user needs to carry the battery housing 1, the first mounting holes 1111 can be disposed on the edge of the first side wall 111 adjacent to the upper plate 12, and then the connecting component is installed on the first mounting holes 1111. The connecting component is provided with a hanging part. An assembly of the hanging part, the connecting component and the first mounting holes makes the battery housing 1 portable. When the battery housing 1 needs to be fixed on the wall, the first mounting holes 1111 can be disposed on the edge of the first side wall 111 adjacent to the fourth side wall 114, and then the battery housing 1 can be fixed on the wall through a cooperation of the first mounting holes 1111 and the fixing component by installing the fixing component such as the screw on the first mounting holes 1111. Specific positions of the first mounting holes 1111 can be disposed on different edges of the first side wall 111 according to the actual situation, which can meet different needs of the user in different scenes.

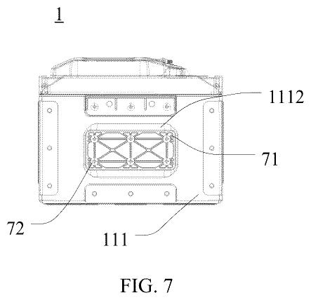

In an illustrated embodiment of the disclosure, as shown in FIG. 6 to FIG. 7, a concave part 1112 is disposed on a middle position of the outside of the first side wall 111. The concave part 1112 is provided with seventh mounting holes 1113, which extend from the outside of the first side wall 111 into the first metal plate 21. The battery housing 1 further includes a pairing plate 71 and fifth mounting components 72. The pairing plate 71 is provided with fifth mounting through-holes 711, which corresponds to the seventh mounting holes 1113. The fifth mounting components 72 are successively penetrated into the fifth mounting through-holes 711 and the seventh mounting holes 1113 to connect the pairing plate 71 to the concave part 1112 of the first side wall 111. In an embodiment of the disclosure, the pairing plate 71 can be a rectangular metal plate, and the fifth mounting components 72 can be screws. In the embodiment of the disclosure, the pairing plate 71 can be used as an ornament by installing the pairing plate 71 on the concave part 1112 of the first side wall 111. When multiple battery housings 1 need to form an integral structure, the pairing plate 71 is disposed on the first mounting holes 1111 of the first side walls 111 of the multiple battery housings 1. Therefore, two of the multiple battery housings 1 form an integral structure by connecting the pairing plate. At this time, the pairing plate 71 can be used as the connecting component.

In an embodiment of the disclosure, the multiple mental plates 20 are embedded in the multiple side walls 11 to improve the structural strength of the multiple side walls 11, thereby improving the overall structural strength of the battery housing 1. In an illustrated embodiment of the disclosure, the protruded height of the first electrode connection terminal 15 and the second electrode connection terminal 16 is lower than that of the protruding part 123, which can prevent accidental electric shock to protect the first electrode connection terminal 15 and the second electrode connection terminal 16 from the falling objects. The embodiment is provided with the first fixing component 51 abutted against the first side wall 111, the first mounting components 52, the second fixing component 53 abutted against the second side wall 112, and the second mounting components 54 to make the battery housing 1 be fixed on the ground or the wall by the first fixing component 51 and the second fixing component 53.

### Embodiment 2

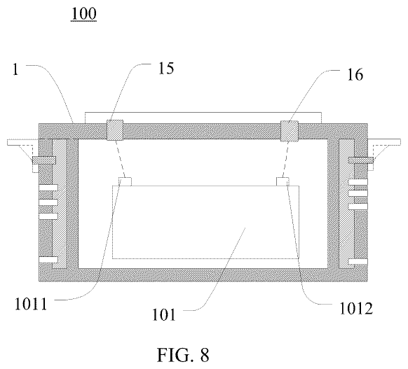

As shown in FIG. 8, the disclosure provides a power source 100, which includes the battery housing 1 according to the Embodiment 1 and a battery 101.

In an embodiment of the disclosure, the battery 101 is a storage battery, such as a liquid lithium ion battery of the related art. The battery 101 includes a positive electrode 1011 and a negative electrode 1012. The battery 101 is disposed in the holding cavity 14 of the battery housing 1, and the positive electrode 1011 is connected to the first electrode connection terminal 15 of the battery housing 1, and the negative electrode 1012 is connected to the second electrode connection terminal 16 of the battery housing 1.

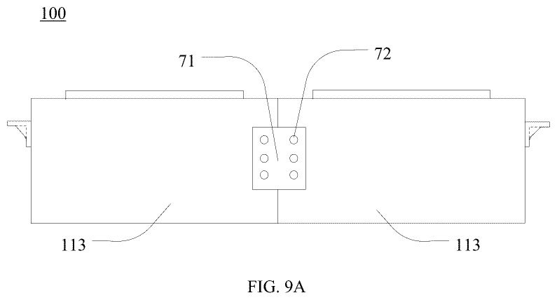

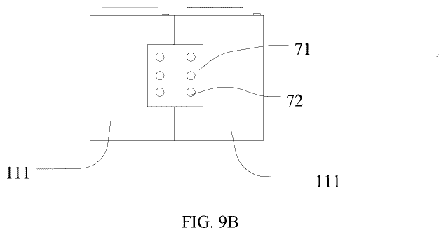

As shown in FIG. 9A to FIG. 9B, in an embodiment of the disclosure, a number of the battery housing 1 is two, and the two battery housing 1 are connected to each other by the pairing plate 71, as shown in FIG. 9A. The pairing plate 71 of the embodiment is disposed on the third mounting holes 1131 of the third side wall 113 adjacent to the second side wall 112 of one battery housing of the two battery housings and the third mounting holes 1131 of the third side wall 113 adjacent to the first side wall 111 of another battery housing of the two battery housings. And the two battery housings 1 are connected through the third mounting holes 1131 disposed on the third side walls 113 of the two battery housings 1.

As shown in FIG. 9B, the pairing plate 71 of the embodiment is disposed on the first mounting holes 1111 of the first side wall 111 adjacent to the third side wall 113 of one battery housing of the two battery housings and the first mounting holes 1111 of the first side wall 111 adjacent to the fourth side wall 114 of another battery housing of the two battery housings. And the two battery housings 1 are connected through the cooperation of the first mounting holes 1111 disposed on the first side walls 111 of the two battery housings, the pairing plate 71 and the fifth mounting components 72 to form the integral structure. In other embodiments of the disclosure, more than two battery housings 1 can also be connected, and the connection mode can also refer to the connection mode shown in FIG. 9A or FIG. 9B, which is not limited herein.

In an embodiment of the disclosure, when multiple battery housings 1 are required to be connected to form a whole structure, the multiple battery housings 1 can be connected through the pairing plate 71, the fifth mounting components 72 and the mounting holes disposed on the multiple side walls 11 to form a power source.

The power source in the disclosure can be used to provide power source for devices or systems such as caravans, golf carts, uninterruptible power systems (USP), and small energy storage systems.

In addition, it can be understood that the above embodiments are only illustrative embodiments of the disclosure. Therefore, the technical schemes of the embodiments can be combined and used arbitrarily on a basis that the technical features of the embodiments are not conflicting, the structures of the embodiments are not contradictory, and the embodiments do not violate the purpose of the disclosure.

A unit or module described as a separated part can be or cannot be separated in a physical sense. And the part displayed as the unit or the module can be or cannot be a physical unit, that is, the separated parts can be located in one place, or be distributed to multiple network units. Some or all of the units or modules can be selected according to the actual needs to achieve technical schemes of the embodiments.

In addition, each functional unit or module in the embodiments of the disclosure can integrate in a processing unit or module, or exist physically independently. Furthermore, two or more units or modules can integrate in a unit or module. The above integrated units or modules can be realized by hardware or hardware with software functional units or modules.

Finally, it should be noted that the above embodiments are only used to illustrate the technical schemes of the disclosure, but not to limit the disclosure. Although the disclosure has been described in detail with reference to the above embodiments, those skilled in the art should understand that it is still possible to modify the technical schemes recorded in the embodiments, or make equivalent replacements of some technical features. However, the modifications or replacements do not make the essence of the corresponding technical schemes deviate from the spirit and scope of the protection of the embodiments of the disclosure.

What is claimed is:

1. A battery housing, comprising:
a plastic housing body, wherein the plastic housing body comprises:
an upper plate, wherein the upper plate is provided with a first through-hole and a second through-hole;
a bottom plate;
a plurality of side walls, connected between the upper plate and the bottom plate individually; wherein the upper plate, the bottom plate and the plurality of side walls together define a holding cavity configured to hold a battery;
a first electrode connection terminal and a second electrode connection terminal, configured to connect to electrodes of the battery, and wherein the first electrode connection terminal is disposed in the first through-hole and the second electrode connection terminal is disposed in the second through-hole; and
a plurality of mental plates, embedded in the plurality of side walls respectively.

2. The battery housing according to claim 1, wherein the plurality of mental plates comprise a first mental plate and a second mental plate, the plurality of side walls comprise a first side wall and a second side wall;
wherein the first side wall and the second side wall are disposed opposite to each other and connected between the upper plate and the bottom plate; the first metal plate is embedded in the first side wall, and the second metal plate is embedded in the second side wall;
wherein the first side wall is provided with a plurality of first mounting holes, the plurality of first mounting holes extend from an outside of the first side wall into the first metal plate; and
wherein the second side wall is provided with a plurality of second mounting holes, the plurality of second mounting holes extend from an outside of the second side wall into the second metal plate.

3. The battery housing according to claim 2, wherein the plurality of first mounting holes are disposed on edges of the first side wall, and the plurality of second mounting holes are disposed on edges of the second side wall.

4. The battery housing according to claim 2, wherein the plurality of side walls further comprise a third side wall and a fourth side wall, wherein the third side wall and the fourth side wall are disposed opposite to each other, connected between the upper plate and the bottom plate, and connected between the first side wall and the second side wall;
wherein a first extension part and a second extension part are disposed on opposite ends of the first metal plate respectively; the first extension part extends from an end of the first metal plate adjacent to the third side wall to an end of the third side wall adjacent to the first side wall; the second extension part extends from another end of the first metal plate adjacent to the fourth side wall to an end of the fourth side wall adjacent to the first side wall;
wherein the third side wall is provided with a plurality of third mounting holes, the plurality of third mounting holes extend from an outside of the third side wall into the first extension part;
wherein the fourth side wall is provided with a plurality of fourth mounting holes, the plurality of fourth mounting holes extend from an outside of the fourth side wall into the second extension part.

5. The battery housing according to claim 4, wherein the plurality of mental plates further comprise a third mental plate and a fourth mental plate; the third mental plate is embedded in another end of the third side wall adjacent to the bottom plate; the fourth mental plate is embedded in another end of the fourth side wall adjacent to the bottom plate;
wherein the third side wall is provided with a plurality of fifth mounting holes, the plurality of fifth mounting holes extend from the outside of the third side wall into the third mental plate; and
wherein the fourth side wall is provided with a plurality of sixth mounting holes, the plurality of sixth mounting holes extend from the outside of the fourth side wall into the fourth mental plate.

6. The battery housing according to claim 1, wherein the upper plate is provided with a protruding part and a protruded height of the protruding part is higher than that of the first electrode connection terminal and the second electrode connection terminal.

7. The battery housing according to claim 2, wherein the battery housing further comprises a first fixing component, a plurality of first mounting components, a second fixing component and a plurality of second mounting components;
wherein the first fixing component is provided with a plurality of first mounting through-holes; the second fixing component is provided with a plurality of second mounting through-holes;
wherein the first fixing component is abutted against the first side wall, each of the plurality of first mounting components is successively penetrated into a corresponding one of the plurality of first mounting through-holes and a corresponding one of the plurality of first mounting holes to connect the first fixing component to the first side wall; the second fixing component is abutted against the second side wall, each of the plurality of second mounting components is successively penetrated into a corresponding one of the plurality of second mounting through-holes and a corresponding one of the plurality of second mounting holes to connect the second fixing component to the second side wall.

8. The battery housing according to claim 5, wherein the battery housing further comprises a third fixing component, a plurality of third mounting components, a fourth fixing component and a plurality of fourth mounting components;
wherein the third fixing component is provided with a plurality of third mounting through-holes; the fourth fixing component is provided with a plurality of fourth mounting through-holes;
wherein the third fixing component is abutted against the third side wall, each of the plurality of third mounting components is successively penetrated into a corresponding one of the plurality of third mounting through-holes and a corresponding one of the plurality of third mounting holes to connect the third fixing component to the third side wall; the fourth fixing component is abutted against the fourth side wall, each of the plurality of fourth mounting components is successively penetrated into a corresponding one of the plurality of fourth mounting through-holes and a corresponding one of the plurality of fourth mounting holes to connect the fourth fixing component to the fourth side wall.

9. The battery housing according to claim 2, wherein a middle position of the outside of the first side wall is provided with a concave part; the concave part is provided with a plurality of seventh mounting holes, and the plurality of seventh mounting holes extend from the outside of the first side wall into the first metal plate;
wherein the battery housing further comprises a pairing plate and a plurality of fifth mounting components, and the pairing plate is provided with a plurality of fifth mounting through-holes corresponding to the plurality of seventh mounting holes; and
wherein each of the plurality of fifth mounting components is successively penetrated into a corresponding one of the plurality of fifth mounting through-holes and a corresponding one of the plurality of seventh mounting holes to connect the pairing plate to the concave part of the first side wall.

10. The battery housing according to claim 7, wherein the first fixing component and the second fixing component have a same structure comprising a first fixing plate and a second fixing plate connected to the first fixing plate, the first fixing plate is perpendicular to the second fixing plate; and
wherein the second fixing plate of the first fixing component is provided with the plurality of first mounting through-holes, and the second fixing plate of the second fixing component is provided with the plurality of second mounting through-holes.

11. The battery housing according to claim 6, wherein the protruding part and the upper plate together define a cavity configured to hold a battery management chip.

12. The battery housing according to claim 2, wherein the plurality of side walls further comprise a third side wall and a fourth side wall, wherein the third side wall and the fourth side wall are disposed opposite to each other, connected between the upper plate and the bottom plate, and connected between the first side wall and the second side wall;
wherein a first extension part and a second extension part are disposed on opposite ends of the first metal plate respectively, and a third extension part and a fourth extension part are disposed on opposite ends of the second metal plate respectively;
wherein the first extension part extends from one of the opposite ends of the first metal plate into the third side wall; the second extension part extends from the other of the opposite ends of the first metal plate into the fourth side wall; and
wherein the third extension part extends from one of the opposite ends of the second metal plate into the third side wall; the fourth extension part extends from the other of the opposite ends of the second metal plate into the fourth side wall.

13. The battery housing according to claim 8, wherein the third fixing component and the fourth fixing component are L-shaped mental plates.

14. A power source, comprising:
the battery housing according to claim 1; and
the battery, comprising a positive electrode and a negative electrode;
wherein the battery is disposed in the holding cavity of the battery housing, the positive electrode is connected to the first electrode connection terminal of the battery housing, and the negative electrode is connected to the second electrode connection terminal of the battery housing.

15. The power source according to claim 14, wherein the upper plate of the battery housing is provided with a protruding part, the protruding part and the upper plate together define a cavity; and
wherein the power source further comprises a battery management chip, disposed in the cavity and connected to the battery.

16. The power source according to claim 15, wherein the power source further comprises: a communication port and a switch button arranged on the protruding part; the communication port is connected to the battery management chip, and the switch button is connected to the battery.

17. The power source according to claim 15, wherein the battery management chip is configured to detect and control a voltage, a current, and a temperature of the battery, and provide protections with overvoltage, overcurrent, short circuit, and over temperature for the battery.

18. The power source according to claim 14, wherein the plurality of mental plates of the battery housing comprise: a first mental plate and a second mental plate, the plurality of side walls of the battery housing comprise: a first side wall and a second side wall; the first side wall and the second side wall are disposed opposite to each other and connected between the upper plate and the bottom plate; the first metal plate is embedded in the first side wall, and the second metal plate is embedded in the second side wall;
wherein the first side wall is provided with first mounting holes, the first mounting holes extend from an outside of the first side wall into the first metal plate; and the second side wall is provided with second mounting holes, the second mounting holes extend from an outside of the second side wall into the second metal plate;
wherein the power source further comprises: a pairing plate and fifth mounting components, the pairing plate is provided with fifth mounting through-holes, and a number of the battery housing is two;
wherein the fifth mounting components each are successively penetrated into the fifth mounting through-holes and the first mounting holes of the first side walls of the two battery housing to connect the pairing plate with the two battery housing, thereby connecting the two battery housing together.
